(19) United States
(12) Patent Application Publication
(10) Pub. No.: US 2005/0160007 A1
(43) Pub. Date: Jul. 21, 2005

(54) Subscription-based sales system, terminal device, management device, server and program

(75) Inventor: Mio Nita, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/071,325

(22) Filed: Mar. 4, 2005

Related U.S. Application Data
(63) Continuation of application No. PCT/JP03/02069, filed on Feb. 25, 2003.

(51) Int. Cl. G06F 17/60; H04L 9/00

(52) U.S. Cl. 705/18

(57) ABSTRACT

A terminal device constitutes an advance sale system including a portable device having identification means identifying a user according to identification information and storage means storing authentication information on the user identified by the identification means and a server having storage means for correlating/storing the aforementioned authentication information and information on subscription of commodity or service by a user authenticated by the authentication information. The terminal device includes input means receiving input of user identification information, a device interface transmitting/receiving to/from the portable device, means transferring the identification information to the portable device so that the identification means identifies the user, read out means receiving the authentication information from the portable device when the identification means has identified the user, means for a user to subscribe a desired commodity or service, and communication means storing the authentication information and subscription information into the aforementioned server.

This is a continuation of Application PCT/JP2003/02069, filed on Feb. 25, 2003.

### BACKGROUND OF THE INVENTION

1. Technical Field

The present invention relates to a subscription-based sales/settlement system of a commercial article or a service.

2. Background Art

A conventional ticket subscription/settlement system using paper as a medium has such a flow that a ticket is subscribed via a telephone, a window, the Internet, etc., and the paper ticket is purchased and handed to a person in charge when entering.

Further, the following documents are known to the public as technologies for storing subscription information, etc. on, for example, an IC card or a cellular phone, etc. and managing a ticket subscription or settlement thereof.

Patent document 1 discloses a ticket subscription/settlement system utilizing ID information of the cellular phone. In this system, it is checked whether or not the ID information of the cellular phone is coincident with ID information registered, and, if coincident with each other, the cellular phone is used as a substitute for the ticket.

Patent document 2 discloses a ticket subscription/settlement system utilizing an IC card mounted on a cellular phone.

Patent document 3 discloses a method of and a system for subscribing a ticket, paying a charge, and storing and utilizing ticket data on an IC card.

Patent document 4 discloses a ticket subscription/issuance system in which when the ticket can be subscribed, subscription information thereof is entered in an information storage card of a user by use of a special rule, and a ticket issuance terminal, when the information storage card entered with the subscription information by using the special rule is inputted, executes a ticket issuing process based on the subscription information.
[Patent document 1] Japanese Patent Application Laid-Open No. 2002-109343 (Abstract)
[Patent document 2] Japanese Patent Application Laid-Open No. 2002-140742 (Abstract)
[Patent document 3] Japanese Patent Application Laid-Open No. 2000-251146 (Paragraph 0001)
[Patent document 4] Japanese Patent Application Laid-Open No. 6-60100 (Abstract)

### SUMMARY OF THE INVENTION

A risk of being lost and stolen can be given as a problem of the paper medium serving as a ticket. There are many cases in which the subscription/issuance of the ticket is effected half a year or earlier before a concert, and on this occasion possession of the acquired ticket till the very day of the concert without being lost involves a sense of uneasiness. If lost, a ticket center that does not reissue is not rare. In the case of encountering a burglar, a method of confirming identity of the stealer is difficult, and the stealer is easy to enter by use of this ticket and sell the ticket to others.

Even in the case of utilizing electronic information, the card or the cellular phone has hitherto been stored with the subscription information, etc. showing the subscription of, e.g., a concert. Therefore, it follows that “the user carries the card, etc.” means “the user carries the information”. Hence, the risk arising when the card, etc. is lost was not obviated.

Further, in such a system that a portable device such as the IC card, etc. on which a program can be executed is stored with many items of ticket subscription information, a situation might be considered, wherein a size of data that should be stored on this card becomes large enough not to be stored. Moreover, the card capable of storing a large amount of data rises in its unit price.

Still further, such a problem is not limited to the ticket sales. For instance, there is a case of prepaying a charge for a lodging ticket of a hotel, a meal ticket of a restaurant, etc., then receiving a premium ticket through the payment and receiving a predetermined service by this premium ticket. In such a case also, the paper premium ticket has an undeniable possibility in which the premium ticket might be lost or stolen and utilized by the stealer. Further, the same problem arises in the case of purchasing a commercial article on a subscription basis and receiving the commercial article at a predetermined a sales shop with an exchange ticket.

Moreover, the situation is the same in such a case that this type of premium ticket or the exchange ticket is stored on a portable medium such as the IC card.

The present invention was devised in view of these problems inherent in the prior arts. Namely, it is an object of the present invention to provide a technology capable of actualizing subscription-based sales of a commercial article or a service in safety even in the case of using a portable device having a small capacity.

The present invention adopts the following means in order to solve the problems given above. To be specific, the present invention is a terminal device configuring a subscription-based sales system in linkage with a portable device comprising identifying means identifying a user by use of identifying information and storage means stored with authentication information of a user identified by the identifying information, and with a server comprising storage means stored with the authentication information and subscription information showing a subscription of a commercial article or a service by the user authenticated by the authentication information in a way that associates the authentication information and the subscription information with each other, the terminal device comprising input means receiving an input of the identifying information of the user, a device interface transferring and receiving the data to and from the portable device, means transferring the identifying information to the portable device and instructing the identifying means to identify the user, reading means receiving, when the identifying means could identify the user, the authentication information from the portable device, means making the user subscribe a desired commercial article or service, and communication means serving to store the server with the authentication information and the subscription information related to the subscribed commercial article or service.

Herein, the portable device is, e.g., an IC card. This portable device comprises identifying means that identifies the user by identifying information, and storage means stored with authentication information of the user identified by the identifying means.

Herein, the identifying information is information for identifying the user with a user of the portable device. For example, the identifying information is a character string, etc. unknown to users other than this user. This type of identifying means can be actualized by a computer program on a CPU built in the IC card.

The terminal device receives an input of the user's identifying information, transfers the identifying information to the portable device, and makes the identifying means of the portable device identify the user. Then, when the portable device can identify the user by the identifying information, the terminal device receives the user's authentication information from the storage means of the portable device. The authentication information is information used for a predetermined authentication institution to certify identity of the user.

Then, the terminal device makes the user subscribe a desired commercial article or service, and stores the server with the authentication information and the subscription information. Accordingly, this terminal device can, after confirming the identity of the user, store the server with the subscription information of the commercial article or the service together with the information that certifies the user's identity.

Preferably, the terminal device may further comprise means referring to a list of the subscription information stored on the storage means of the server, and means displaying the list of the subscription information.

Thus, the terminal device can display the list of the subscription information of the commercial article or the service subscribed by the user on the basis of the authentication information of the user.

Further, the present invention may also be a management device conducting management of providing a user with a commercial article or a service in linkage with a portable device comprising identifying means identifying a user by use of identifying information and storage means stored with authentication information of a user identified by the identifying information, and with a server comprising storage means stored with the authentication information and subscription information showing a subscription of a commercial article or a service by the user authenticated by the authentication information in a way that associates the authentication information and the subscription information with each other, the management device comprising input means receiving an input of the identifying information of the user, a device interface transferring and receiving the data to and from the portable device, means transferring the identifying information to the portable device and instructing the identifying means to identify the user, reading means receiving, when the identifying means could identify the user, the authentication information from the portable device, means transmitting the authentication information to the server, means receiving a result of judgment as to whether the authentication information is stored together with the subscription information on the server, and a control unit permitting, when the authentication information is stored together with the subscription information on the server, the user to be provided with the commercial article or the service.

Herein, the permission of providing the commercial article or the service connotes, for instance, the permission of entering a concert hall of a subscribed concert, and so on.

Thus, the management device, when the user can be identified by the identifying information inputted by the user, receives the authentication information from the portable device, and checks whether or not the subscription information is stored together with the authentication information on the server. Herein, the case of being stored with the subscription information together with the authentication information implies that the user subscribes, for example, a predetermined commercial article or service.

Accordingly, this management device checks whether or not the user subscribes the predetermined commercial article or service by use of the identifying information of the portable device and the user's authentication information. In this case, the subscription information is stored not on the portable device but on the server. Moreover, the terminal device is unable to receive the authentication information till the valid identifying information is inputted.

Therefore, even in the case where the user subscribing the commercial article or the service loses the portable device, it is possible to reduce a possibility that other person might use the lost portable device.

Preferably, the terminal device may further comprise means applying to an issuance organization for reissuing the authentication information, means obtaining the authentication information from the issuance organization, and means storing the portable device with the obtained authentication information, the server may further comprise means verifying validity of the reissued authentication information, and the control unit may permit, when the server verifies the validity of the authentication information received from the reading means, the user to be provided with the commercial article or the service.

Thus, the server has the means confirming the validity of the reissued authentication information. With this contrivance, the authentication information before being reissued is invalidated, and the reissued authentication information permits the user to be provided with the commercial article or the service.

Accordingly, after subscribing the commercial article or the service, etc., even if the user loses the portable device and if the authentication information is reissued, there decreases the possibility that the authentication information of the lost portable device might be used by others.

Moreover, the user can be provided with the subscribed commercial article or service by use of the reissued authentication information. For instance, the user can enter the concert hall of the concert that was subscribed beforehand owing to the reissued authentication information.

Further, the present invention may also be a server configuring a subscription-based sales system in linkage with a portable device comprising identifying means identifying a user by use of identifying information and storage means stored with authentication information of a user identified by the identifying means, and with a terminal device comprising input means receiving an input of the identifying information of the user, a device interface transferring and receiving the data to and from the portable device, means the making identifying means identify the user by transferring the identifying information to the portable device, reading means receiving the authentication information from the portable device when the identifying means could identify the user with a predetermined user, and means making the user subscribe a desired commercial article or service, the server comprising means receiving the authentication information and subscription information about the commercial article or the service subscribed by the user authenticated by the authentication information, storage means stored with the authentication information and the subscription information in a way that associates the authentication information and the subscription information with each other, and means outputting the stored subscription information or information as to whether the subscription is made or not.

According to the present server, it is possible to receive, store and output, together with the authentication information, the subscription information of the user authenticated by the authentication information of the portable device. Herein, the “output” connotes making, for example, the terminal device on a network display the information.

Preferably, the server may further comprise means accepting a settlement request about the subscription information via the terminal device, and means executing a settlement process in response to the settlement request, wherein the storage means of the server may be stored with information showing completion of the settlement together with the subscription information.

Preferably, the server may further comprise means receiving a completion-of-settlement report about the subscription information, wherein the storage means of the server may be stored with information showing completion of the settlement together with the subscription information. According to the server described above, it is possible to store the information showing the completion of the settlement about the subscription.

Preferably, a server may further comprise means referring to a term of settlement with respect to the subscription information, means recording, when the term of settlement passed and the subscription was invalidated, information about a user making the subscription, means adding up a subscription invalidation count of the invalidated subscriptions per user, and means invalidating the authentication information with respect to the user whose subscription invalidation count reaches a predetermined value.

The present invention may include, an authentication server comprising means accepting a notice about a user whose subscription invalidation count representing how many times the subscription is invalidated due to an elapse over the term of settlement from the server described above, reaches a predetermined value, and means invalidating the authentication information of the notified user when given the notice. Further, a function of this authentication server may be provided in the server described above.

According to the server described above, it is possible to invalidate the authentication information of the user whose subscription gets invalidated many times due to the elapse over the term of settlement.

Preferably, the server may comprise means judging validity of the authentication information stored on the storage means of the server, and means updating, when judging that the authentication information is judged ineffective, the authentication information into an effective piece of authentication information.

According to this server, for instance, after storing the authentication information and the subscription information, the authentication information is reissued, and, even if the original authentication information becomes ineffective, the information can be updated into the effective authentication information and can be stored together with the subscription information. This contrivance prevents an unlawful use of the authentication information which is issued before being reissued, and enables the reissued authentication information to be effective.

As discussed above, according to the present invention, the server manages batchwise the information, and the portable device serves as the means for accessing this server, thereby enhancing the security.

Moreover, the present invention may also be a subscription-based sales system including the portable device, the terminal device and the server. In this case, the server may include a first server stored with the authentication information and the subscription information in a way that associates the authentication information and the subscription information with each other, and a second server providing information to be displayed to the terminal device and providing information inputted from the terminal device to the first server.

Moreover, the present invention may also be a method by which a computer or other device or other machine, etc. executes any one of the processes described above. Furthermore, the present invention may also be a program for making the computer or other device or other machine, etc. actualize any one of the functions described above. Still further, the present invention may also be a storage medium readable by the computer, etc. and stored with such a program.

As discussed above, according to the present invention, it is possible to actualize the subscription-based sales of the commercial article or the service in safety even in the case of using an IC card having a small capacity.

### BRIEF DESCRIPTION OF THE DRAWINGS

FIG. 1 is a view of a whole architecture of an information system according to a first embodiment of the present invention;

FIG. 2 shows an example of a concert information listing screen 10 provided by a Web server 2;

FIG. 3 shows an example of a subscription screen 20 provided by the Web server 2;

FIG. 4 shows an example of a confirmation screen 30 after clocking a subscription button;

FIG. 5 shows an example of a purchase history reference screen 40;

FIG. 6 shows an example of a flowchart showing processes when purchasing in the information system;

FIG. 7 shows an example of a flowchart showing processes when referring to the purchase history;

FIG. 8 shows an example of a flowchart showing processes of an entrance gate management device 4;

FIG. 9 is a view of a whole architecture of the information system in a second embodiment of the present invention;

FIG. 10 shows an example of certificate data in the second embodiment;

FIG. 11 shows an example of a flowchart showing a certificate reissuing process;

FIG. 12 is a conceptual diagram showing a user-based procedure of reissuing the certificate; and

FIG. 13 shows an example of a flowchart showing a certificate invalidation process in a third embodiment of the present invention.

### DETAILED DESCRIPTION OF THE INVENTION

A best mode for carrying out the invention will hereinafter be described with reference to the drawings.

### First Embodiment

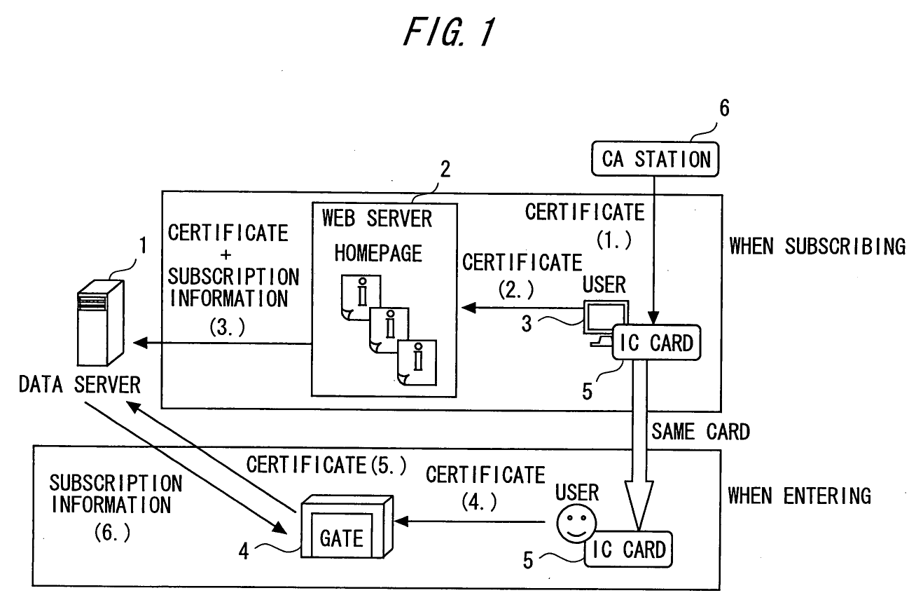

An information system according to embodiments of the present invention will be explained with reference to the drawings in FIGS. 1 through 8.

System Architecture

FIG. 1 shows a view of a whole architecture of this information system. This information system includes a data server 1 for managing commercial articles or services, etc. purchased on a subscription basis by a user, a Web server 2 for providing information about the commercial articles or the services, etc. to the user and providing a Website on which these commercial articles, etc. are subscribed, a terminal 3 utilized for the user to accesses the Web server 2, etc. via a network, an IC card 5 stored with a certificate for authenticating the user when the user subscribes the commercial article or the service, etc., and a gate management device 4 for authenticating the user when the user receives an offer of the subscribed commercial article or service, etc. and permitting the authenticated user to receive the offer of the commercial article or the service, etc.

The data server 1 manages the information about the commercial article or service subscribed by the user together with the certificate data for authenticating the user. The information managed by this data server 1 is termed subscription information. In the first embodiment, a concert ticket or event-holding (performance) of the concert is assumed as the commercial article or the service to be subscribed. In the first embodiment, however, the commercial article or the service to be subscribed is not limited to the concert ticket.

The subscription information contains a provider (e.g., a name of a ticket sales company) of the commercial article or the service, a name (e.g., a concert name) of the commercial article or the service, a date (e.g., an event holding date/time of the concert) when delivering the commercial article or providing the service, a place (e.g., an event holding place of the concert) to which the commercial article is delivered or where the service is provided, specifications of the commercial article or the service (e.g., a seat number in the concert hall), a payment status and so on.

The data server 1, when a new subscription occurs, stores the subscription information thereof in response to a request given from the Web server 2. Further, the data server 1 provides information on a subscription list (which is also called a purchase history) per user in response to the request given from the Web server 2.

Moreover, the data server 1, when the user is provided with the subscribed commercial article or service, judges based on the certificate data provided by the user whether the subscription by the user is valid or not. For example, if the user is a person who subscribed a ticket of an event such as the concert, etc., the data server 1 judges from the certificate data for authenticating the user whether the user's subscription is valid or not for the sake of the gate management device 4 that manages an entrance gate of the concert hall.

The Web server 2 provides the Website (which is also referred to as a homepage, a Website or simply a page) on which the user subscribes the commercial article or the service, etc. Further, the Web server 2 provides a Website on which a user's purchase history is provided.

Each of the data server 1 and the Web server 2 is a general type of computer having a communication function via the network, of which the configuration and operation are broadly known, and therefore their explanations are omitted.

The user accesses the Web page provided by the Web server 2 via the network, and subscribes the commercial article or the service. The subscription of the commercial article or the service connotes, for instance, the subscription-based purchase of the commercial article, the subscription-based purchase of a ticket of a chargeable event such as the concert, etc., and the subscription-based purchase of a ticket of transportation.

The terminal 3 is a general type of information device, e.g., a personal computer that has an IC card I/O interface (which will hereinafter be simply called a card reader/writer).

In the case of utilizing the present information system, the user previously receives issuance of the user's own certificate data from an authentication station 6 (which is shown as a CA station in FIG. 1).

The certificate data is defined in X.509 of ITU-T (International Telecommunication Union-Telecommunications) Recommendations, and contains pieces of user personal information (e.g., an assigned organization, an identification name, a personal name, etc.), a public key, a digital signature of the authentication station 6, and so forth. Falsification of the certificate data can be detected from the digital signature.

The digital signature involves, for example, encrypting a predetermined document with a user's secret key, decrypting the encrypted document with a public key corresponding to this secret key and thus confirming that the signature is written by (belongs to) the user himself or herself when the predetermined document is obtained, and the digital signature is an encryption technology as such.

The user sends a predetermined certificate request (Certificate Request) to the authentication station 6, and is provided with the certificate. The certificate request is also specified in X.509 of ITU-T Recommendations. One example of a certificate issuing procedure will be exemplified for facilitating comprehension of the first embodiment.

The user takes the following procedure for acquiring the certificate. To begin with, the user generates a secret key and a public key based on a predetermined method. Then, the user registers the generated secret key and public key in an authentication station 6 that manages the keys. The authentication station 6 may also generate, after confirming the user identity, the secret key and the public key. Note that the authentication station 6 is herein assumed to manage the secret key and the public key, however, there is a mode in which a registration station 6 different from the authentication station 6 manages the secret key and the public key.

Next, the user sends the certificate request containing the user's public key to the authentication station 6.

The authentication station 6 confirms by some method that the public key contained in the sent certificate request belongs to the user himself or herself. This may involve, for instance, attaching a user's signature using the secret key to the certificate request. The signature can be generated by, e.g., encrypting the certificate request or a its message digest with the secret key.

The authentication station 6 decrypts the signature of the user with the user's public key and, when the certificate request or the message digest can be decrypted, confirms that the signature is written by the user himself or herself.

Based on such confirmation, the certificate data for this user is generated and provided to the user (Certificate 1. in FIG. 1).

The certificate data may be provided to the user via the network. A serial number (that will hereinafter be referred to as an issuance count), which differs according to the same certificate request made plural number of times, may be assigned to the certificate data. With this contrivance, it never happens that the same certificate data is issued plural number of times.

The user stores the IC card 5 with the certificate data obtained into the terminal 3 via the network. The user may, however, obtain the IC card 5 stored with the certificate data from the authentication station 6.

The IC card 5 includes a memory and a CPU and is managed under the control of a computer program. For example, a smart card is known as this type of IC card 5.

This type of IC card 5 needs, when reading the stored information, inputting PIN (Personal Identification Number), and, when the valid PIN and a valid password are inputted, outputs the stored information.

The user acquiring the certificate data inserts the IC card 5 containing the certificate data into the card reader/writer of the terminal 3 and thereby accesses the Web page of the Web server 2. Then, the user subscribes a desired commercial article or service, e.g., a ticket of a concert. When subscribing this ticket, the terminal 3 reads the certificate data from the IC card 5 and provides the certificate data to the Web server 2 (Certificate 2. in FIG. 1).

The Web server 2 transmits, to the data server 1, the subscription information on the subscribed commercial article or service and the user's certificate data sent from the terminal 3. The data server 1 stores the received subscribed information and certificate data (Certificate 3. in FIG. 1) in a way that pairs the subscription information with the certificate data.

The user, in the case of being provided with the subscribed commercial article or service, e.g., when entering the concert hall, carries the IC card 5. The gate management device 4 at the hall requests the user who enters to present the certificate data. The user has the certificate data in the IC card 5 read by the card reader/writer of the gate management device 4 (Certificate 4. in FIG. 1). The gate management device 4 transmits the readout certificate data to the data server 1 (Certificate 5. in FIG. 1), and requests the data server 1 to search for the subscription information on the basis of the user's certificate data.

The data server 1, when the subscription information could be searched for, notifies the gate management device 4 of this purport. The gate management device 4 receives a search result of the subscription information from the data server 1 (Subscription Information 6. in FIG. 1) and, when the subscription by the user could be confirmed, permits the user to enter.

Screen Configuration

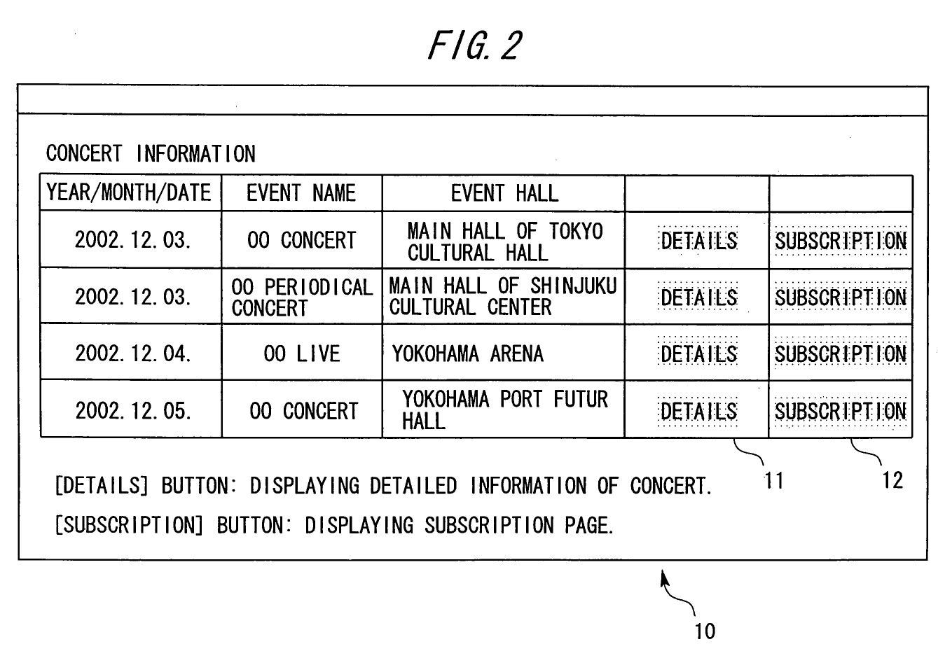

FIG. 2 shows an example of a concert information listing screen 10 on the Website provided by the Web server 2. The concert information listing screen 10 is displayed when, for example, the concert information is selected as a subscription object category on the Website (which will hereinafter be called a subscription site) through which the user subscribes the commercial article or the service.

The concert information listing screen 10 displays a concert information list. Each of rows in this list corresponds to one record of concert information. Each row has respective fields such as a year/month/date, an event name, a place, a detail button 11 and a subscription button 12.

The year/month/date represents a date when the concert is held. The event name is a name for identifying the concert. The place is a name of the place where the concert is held.

When pressing the detail button 11, detailed information of the concert is displayed. Further, when pressing the subscription button 12, a subscription screen for subscribing the concert is displayed.

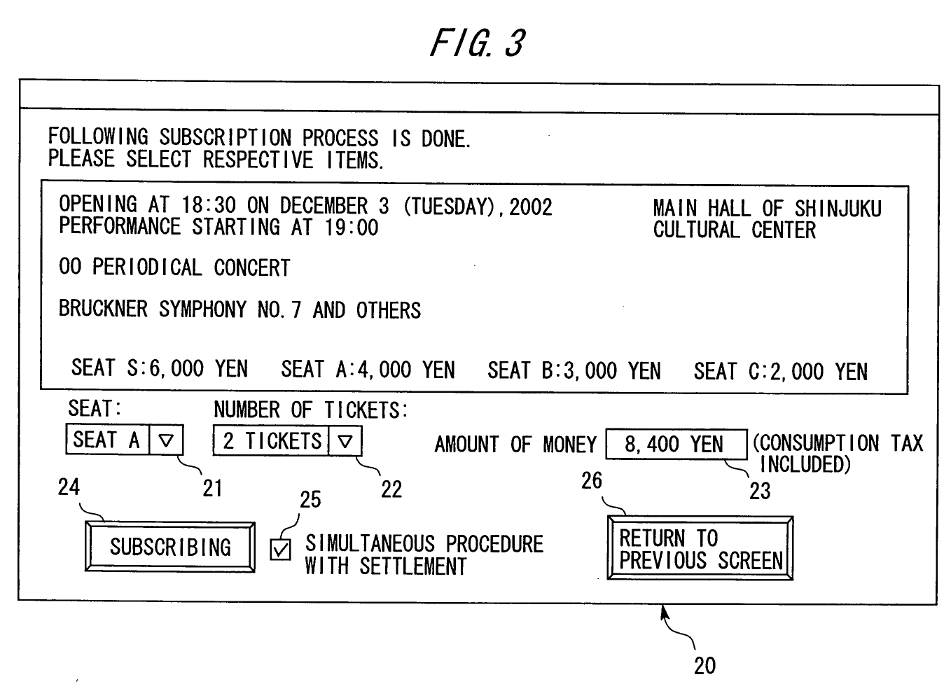

FIG. 3 shows an example of a subscription screen 20 provided by the Web server 2. The subscription screen 20 is displayed when pressing the subscription button 12 on the concert information listing screen 10 in FIG. 2.

The subscription screen 20 displays the detailed information of the event such as the concert, etc. in a central area from an upper part of the screen. Further, the subscription screen 20 has a seat type selection button 21, a number-of-tickets designating button 22, an amount of money display box 23, a subscription button 24, a settlement designating box 25 and a previous screen button 26 under the detailed information of the event.

For instance, pieces of information such as “Opening: 18:30, Dec. 3, 2002”, etc. are displayed as the detailed information of the event.

A type of the seat is selected by the seat type selection button 21. For example, a seat A, a special seat, a second floor seat, etc. are selected. The number of tickets is designated by the number-of-tickets designating button 22. An amount of money for purchasing, which is based on the selected type of seat and the designated number of tickets, is displayed in the amount of money display box 23.

The subscription button 24 is a button pressed when the user decides to subscribe. When a checkmark is inputted to the settlement designating box 25, a settlement process is executed when subscribed. When pressing the previous screen button 26, the display returns to the concert information listing screen 10 in FIG. 2.

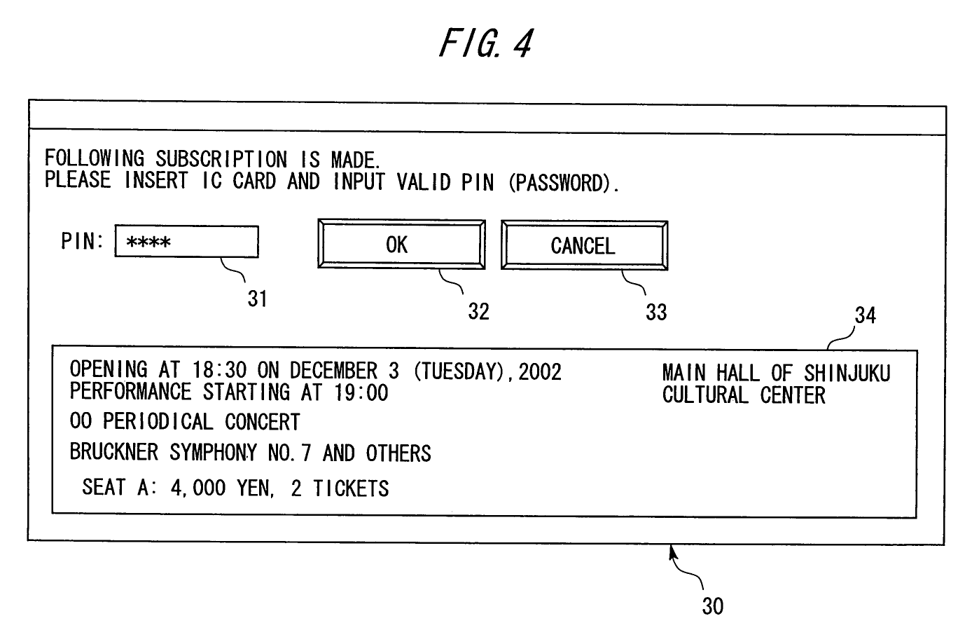

FIG. 4 shows an example of a confirmation screen 30 after clicking the subscription button. The confirmation screen 30 is displayed when setting the checkmark in the settlement designating box 25 and pressing the subscription button 24 on the subscription screen in FIG. 3. The confirmation screen 30 has a display area of a message for prompting the user to insert the IC card 5 and to input the PIN, a PIN input box 31, an OK button 32, a cancel button 33 and a subscription content display box 34.

The user inserts the IC card 5 into the card reader/writer of the terminal 3, inputs the PIN defined in the user's IC card 5, and presses the OK button 32. The subscription is thereby established. Further, at this time, a charge for the ticket of the subscribed concert is paid from a predetermined bank account or a credit card account. While on the other hand, when the user presses the cancel button 33, the display returns to the subscription screen 20 in FIG. 3.

Note that if the user presses the subscription button 24 without setting the checkmark in the settlement designating box 25 on the subscription screen 20 in FIG. 3, a message such as “Please, do the settlement process by O-th Day in O-th Month” is displayed on the confirmation screen 30.

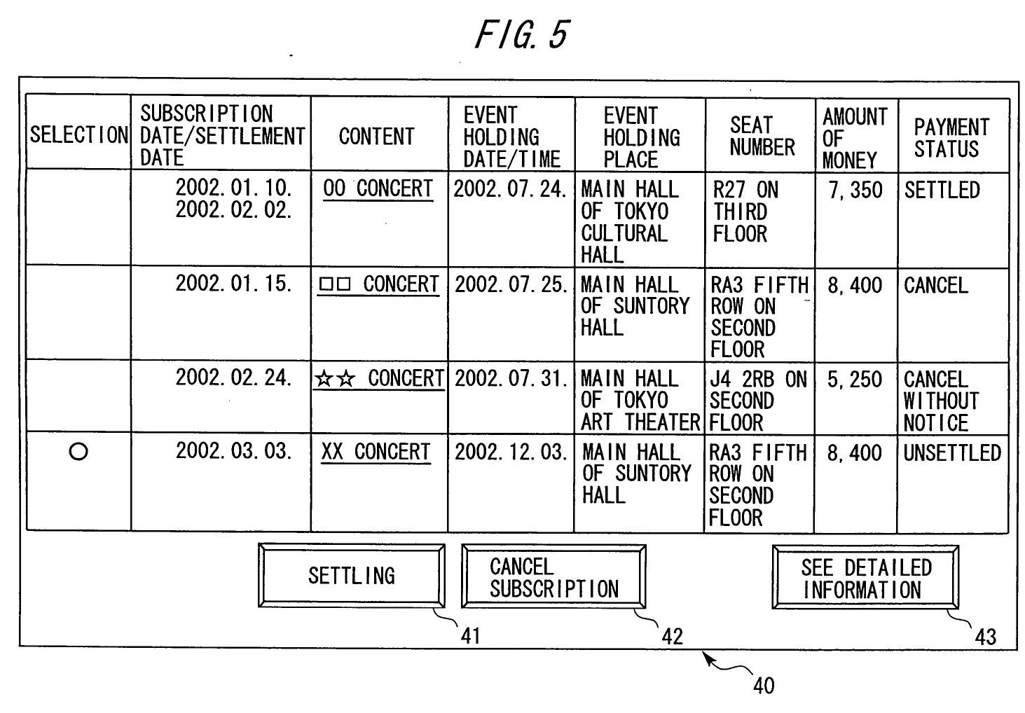

FIG. 5 shows an example of a purchase history reference screen 40. The purchase history reference screen 40 displays pieces of list-formatted information of the tickets purchased by the users. Each of rows in this list corresponds a content of the subscription, i.e., the event information of the purchased ticket. Each row in this list has a selection field, a subscription date/settlement date field, a content field, an event holding date/time field, an event holding place field, a seat number field, an amount of money field, and a payment status field. Further, a settlement button 41, a cancel button 42 and a detailed information button 43 are displayed under the purchase history reference screen 40.

An object manipulated by the settlement button 41, the cancel button 42 and the detailed information button 43 is designated in the selection field in the list. For instance, if the user selects an “XX” concert on Mar. 3, 2002 and presses the settlement button 41, the settlement process of a subscription charge for this concert is executed.

A year/month/date when the manipulation for the subscription was executed and a year/month/date when the manipulation for the settlement was executed, are displayed in the subscription date/settlement date field. A name of the event as the subscription object is displayed in the content field.

A date/time when the event is held is displayed in the event holding date/time field. A name of the place where the event is held is displayed in the event holding place field. In the present information system, when the user clicks the name of the event holding place by use of a pointing device such as a mouse, etc. provided on the terminal 3, the detailed information of the event holding place is displayed.

A seat number subscribed by the user is displayed in the seat number field. Further, if the user subscribes a plurality of tickets, the seat numbers of the plurality of tickets are displayed in the seat number field. An amount of money necessary for the settlement is displayed in the amount of money field.

The following information is displayed in the payment status field, depending on a state of whether the settlement of the charge is completed or not.

(1) Settled: this indicates that the settlement was normally completed.

(2) Unsettled: this indicates a state where the settlement is not yet completed and shows a wait for the settlement.

(3) Cancel: this indicates that the subscription is canceled by the user's manipulation.

(4) Cancel without notice: this indicates that a term of payment passed without executing the settlement process after the subscription, and the subscription is invalidated.

The user designates an unsettled event as a manipulation object in the selection field, and presses the settlement button 41, whereby the subscription charge for this event can be settled.

Moreover, the user designates the unsettled event as the manipulation object in the selection field, and presses the cancel button 42, whereby this event can be canceled beforehand.

Still further, the user designates the manipulation object in the selection field, and presses the detailed information button 42, thereby enabling the detailed information of this event to be displayed.

Processing Flow and Effect in System

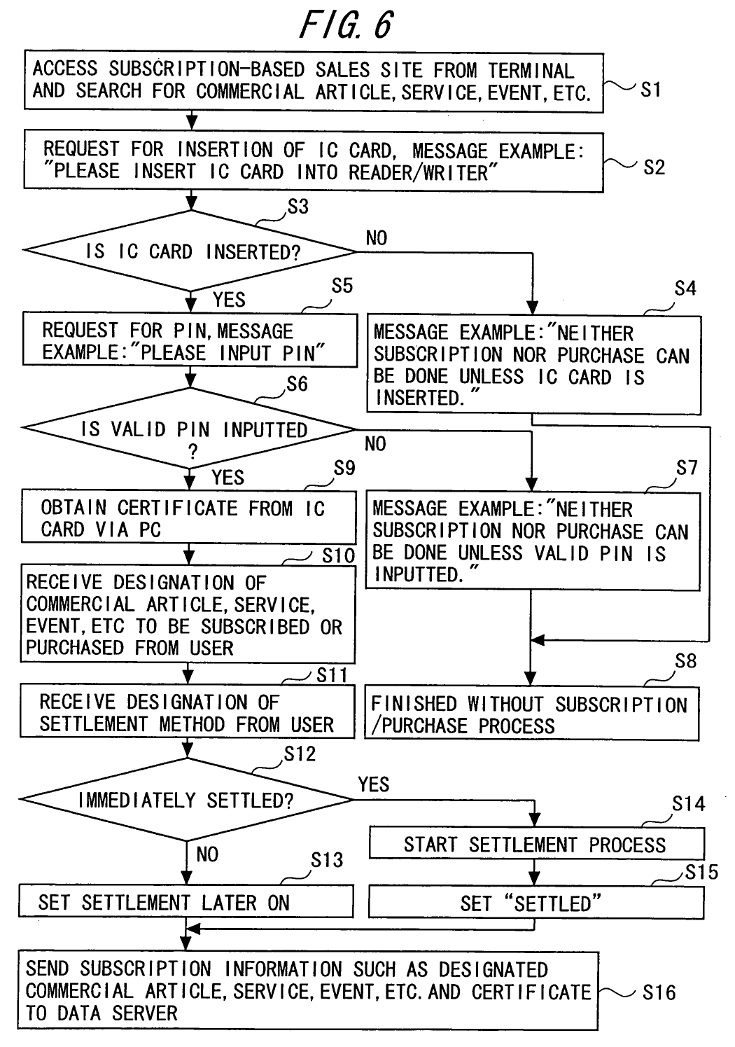

FIG. 6 shows processes in the information system when purchasing on the subscription basis. These processes represent processes of programs executed by the terminal 3, the Web server 2 and the data server 1 when the user accesses the Web page of the Web server 2 through the terminal 3. These processes are actualized based on, e.g., HTTP (HyperText Transfer Protocol) by Browser on the terminal 3 and server programs of the Web server 2 and of the data server 1.

To start with, the user accesses the Web page through the terminal 3, and searches for the commercial article, the service or the event, etc. (S1).

Next, the terminal 3 requests the user to insert the IC card 5 into the card reader/writer. This request is given in such a way that, for instance, the terminal 3 displays a message “Please insert the IC card into the card reader/writer” on its display (S2).

If the IC card 5 is not inserted even after a predetermined period of time has elapsed, the terminal 3 displays a message “neither the subscription nor the purchase can be made unless the IC card is inserted” on its display (S4). Thereafter, the terminal 3 finishes the process without executing the subscription/purchase process (S8).

While on the other hand, when the IC card 5 is inserted in response to the request in S2, the web server 2 requests the user to input the PIN. This request is given as, e.g., a message “Please input the PIN” (S5).

In response to the request in S5, if a valid PIN is not inputted even after the elapse of the predetermined time, the terminal 3 displays a message “neither the subscription nor the purchase can be made unless the PIN is inputted” on its display (S7). Thereafter, the terminal 3 finishes the process without executing the subscription/purchase process (S8).

While on the other hand, when the valid PIN is inputted in response to the request in S2, the terminal 3 obtains the certificate data from the IC card 5 via the terminal 3 (e.g., the personal computer) (S9).

Next, the terminal 3 receives the designation of the commercial article, the service or the event, etc. to be subscribed from the user (S10). Further, the terminal 3 receives from the user the designation of the settlement method, i.e., about whether the settlement is immediately done or not (S11). The designation of the commercial article, the service or the event, etc. and the designation of the settlement method are transferred to the Web server 2 from the terminal 3.

If immediately settled, the Web server 2 instructs the terminal 3 to display the screen on which the settlement process is executed, and the settlement process is executed thereon (S14). Through this settlement process, a charge for the subscribed commercial article, service or event, etc. is paid from the predetermined bank account or the credit card account. Then, the Web server 2 sets “Settled” in the information that is transmitted to the data server 1 (S15).

Whereas if not immediately settled, the Web server 2 sets a purport that the settlement will be made later on in the information that is transmitted to the data server 1 (S13).

Next, the Web server 2 transmits, to the data server 1, the subscription information containing the category of the designated commercial article, service or event, etc. and the information about whether the settlement is done or not, and also the user's certificate (S16). The data server 1 stored a database with the transmitted information.

In this case, the Web server 2 transfers the subscription information and the designation of the settlement to the data server 1, and the settlement process may also be executed in the data server 1. The data server 1 may pay the charge for the subscribed commercial article, service or event, etc. from the predetermined bank account or the credit card account on the basis of the user information registered beforehand.

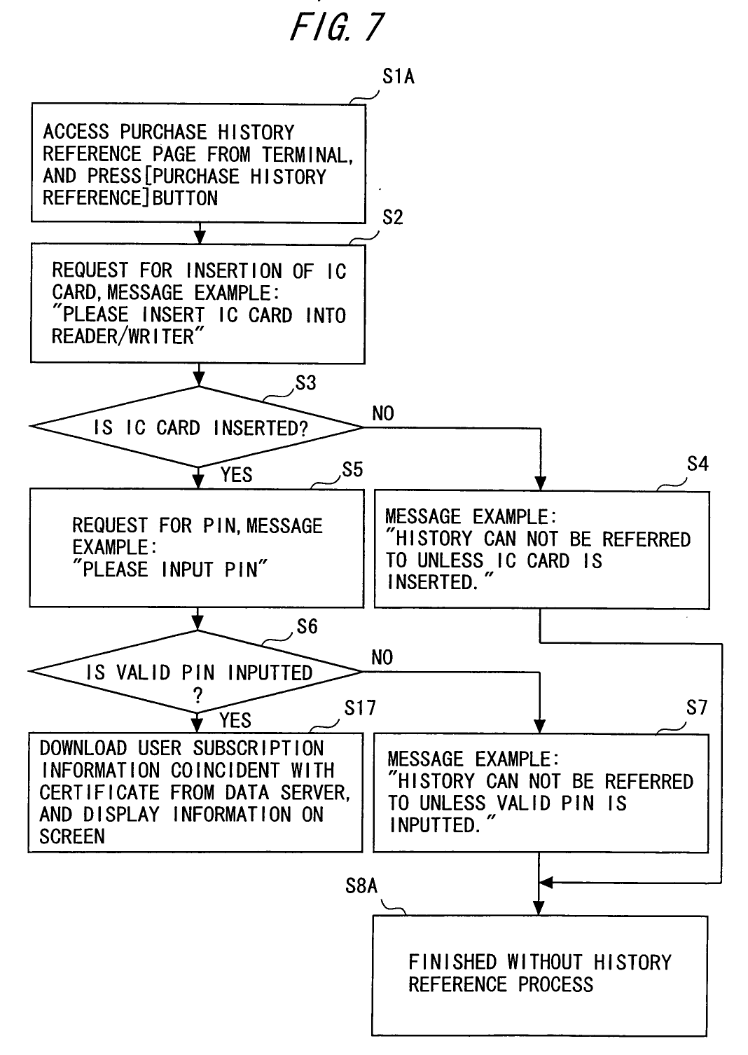

FIG. 7 shows an example of a flowchart for referring to the purchase history. The processes for referring to the purchase history are actualized by the programs on the terminal 3, the Web server 2 and the data server 1 in the same way as the processes for purchasing in FIG. 6 are actualized. Among the processes in FIG. 7, the process other than S1A, S8A and S17 are the same as those in FIG. 6. Such being the case, the same processes are marked with the same numerals and symbols as those in FIG. 6, and their explanations are omitted.

In this process, at first, the user accesses a purchase history reference page through the terminal 3, and presses the purchase history reference button (S1A). Thereat, the terminal 3 executes the processes from S3 through S7 as in FIG. 6.

Then, if the IC card 5 is not inserted into the card reader/writer, or if the valid PIN is not inputted, the terminal 3 finishes the process without executing the history reference process (S8A).

While on the other hand, when the IC card 5 is inserted into the card reader/writer, and when the valid PIN is inputted, the terminal 3 reads the certificate data from the IC card 5. Then, the terminal 3 transmits the certificate data to the Web Server 2 and requests the Web server 2 to search for the purchase history.

The Web server 2 transfers the transmitted certificate data to the data server 1 and requests the data server 1 to search for the purchase history. A search result is transmitted to the Web server 2 and displayed on the display of the terminal 3 (S17).

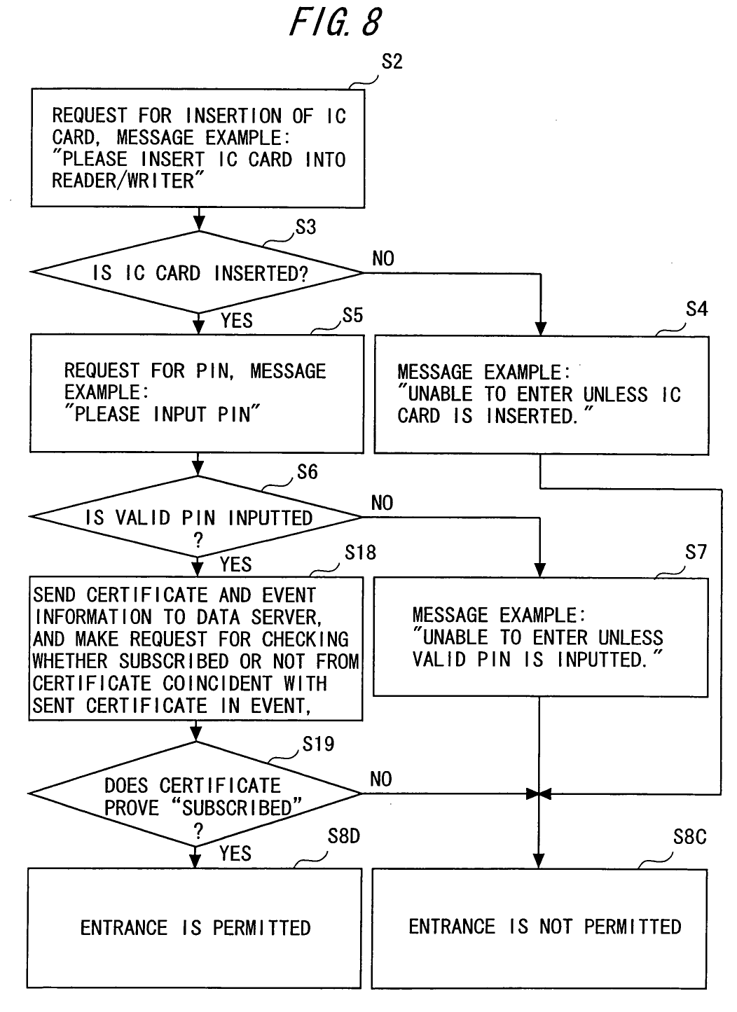

FIG. 8 is a flowchart showing processes of the gate management device 4 that manages the entrance gate of the event hall, etc. These processes are actualized by the programs on the gate management device 4 and on the data server 1.

Among the processes in FIG. 8, the process other than S8C, S8D and S18 through S19 are the same as those in FIG. 6. Such being the case, the same processes are marked with the same numerals and symbols as those in FIG. 6, and their explanations are omitted.

In this process, at first, the gate management device 4 requests the user to insert the IC card 5 into the card reader/writer (S2). Thereat, the gate management device 4 executes the processes from S3 through S7 in the same way as the terminal 3 in FIG. 6 does.

Then, if the IC card 5 is not inserted, or if the valid PIN is not inputted, the gate management device 4 finishes the process without permitting the user to enter the hall (S8C).

While on the other hand, when the IC card 5 is inserted, and when the valid PIN is inputted, the gate management device 4 reads the certificate data from the IC card 5. Then, the gate management device 4 sends the certificate data to the data server 1, and requests the data server 1 to check whether or not the subscription is made by use of the certificate data coincident with the certificate with respect to the event concerned (S18).

When the event concerned is subscribed by using the certificate data read from the IC card 5, the gate management device 4 permits the user to enter the event hall, and finishes the process (S8D).

Further, if the event concerned is not subscribed by use of the certificate data read from the IC card 5, the gate management device 4 terminates the process without permitting the user to enter the event hall (S8C).

As discussed above, according to the present information system, the user subscribes the commercial article, the service, etc. on the basis of the certificate data stored on the IC card 5. Then, the subscription information showing the content of the subscription and the user's certificate data are recorded in the data server 1.

Hence, the subscription information itself, which shows the content of the subscription, is stored in the data server 1 separately from the IC card 5, and there decreases a risk of the IC card 5 being immediately abused by other persons even if the user loses the IC card 5 and so on.

In the present information system, the IC card 5 is stored with the certificate data of the user but is not accumulated with the subscription content, e.g., the subscription information showing the content of the event such as the category, the name, the date/time, etc. of the event. Accordingly, there is no necessity of increasing a storage capacity of the IC card 5, and the information system can be built up by the inexpensive IC cards 5.

Further, the case of utilizing the certificate data on the IC card 5 requires inputting the PIN information, and there decreases the risk of the IC card 5 being immediately abused by other persons even if the user loses the IC card 5, and so on.

### MODIFIED EXAMPLE

In the first embodiment, the embodiment of the present invention has been explained by exemplifying the subscription of the concert. The embodiment of the present invention is not limited to the applied example given above. The embodiment of the present invention can be configured in the same screen configurations as those in FIGS. 2 through 5 also in the subscription of other events such as movies, dramas, etc., the purchase-subscription of the commercial article and the subscription of the service for travels, accommodations, etc.

The first embodiment has exemplified the information system in which the data server 1, the Web server 2, the terminal 3 and the gate management device 4 are in linkage with each other. The embodiment of the present invention is not, however, limited to this configuration. For example, the data server 1 and the Web server 2 may be constructed of the same computer.

Further, the data server 1 may also be constructed of a plurality of computers that are in linkage with each other on the network. Moreover, the Web server 2 may also be constructed of a plurality of computers that are in linkage with each other on the network.

The first embodiment has exemplified the information system including the gate management device 4 installed at the event hall of the concert, etc. The embodiment of the present invention is not, however, limited to this configuration. For instance, the terminal 3 as a substitute for the gate management device 4 may also be installed at the concert hall.

In short, an available information device is a device capable of reading the certificate data from the IC card 5 carried by the user and querying the data server 1 about whether the commercial article or the service can be provided or not, and such a device is not limited to the gate management device 4.

### Second Embodiment

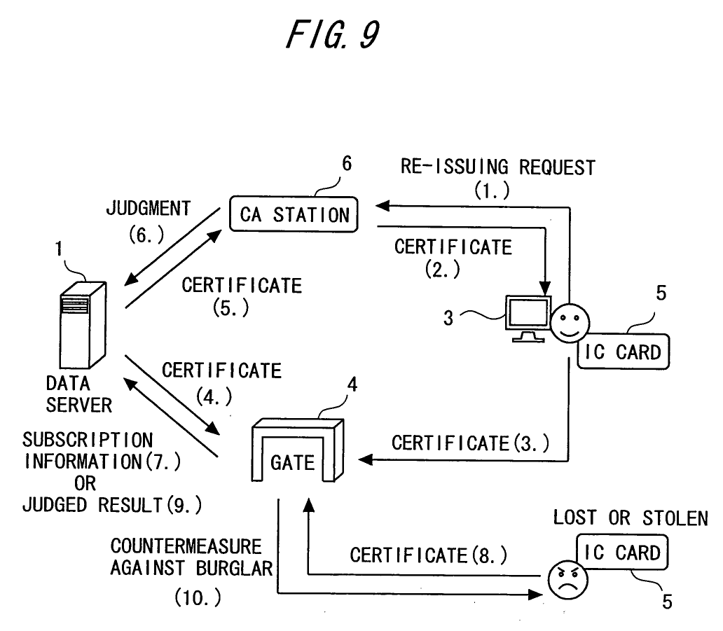

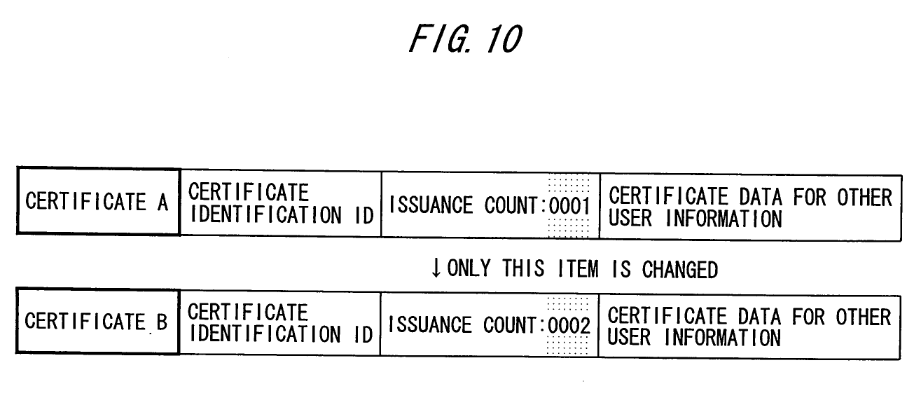

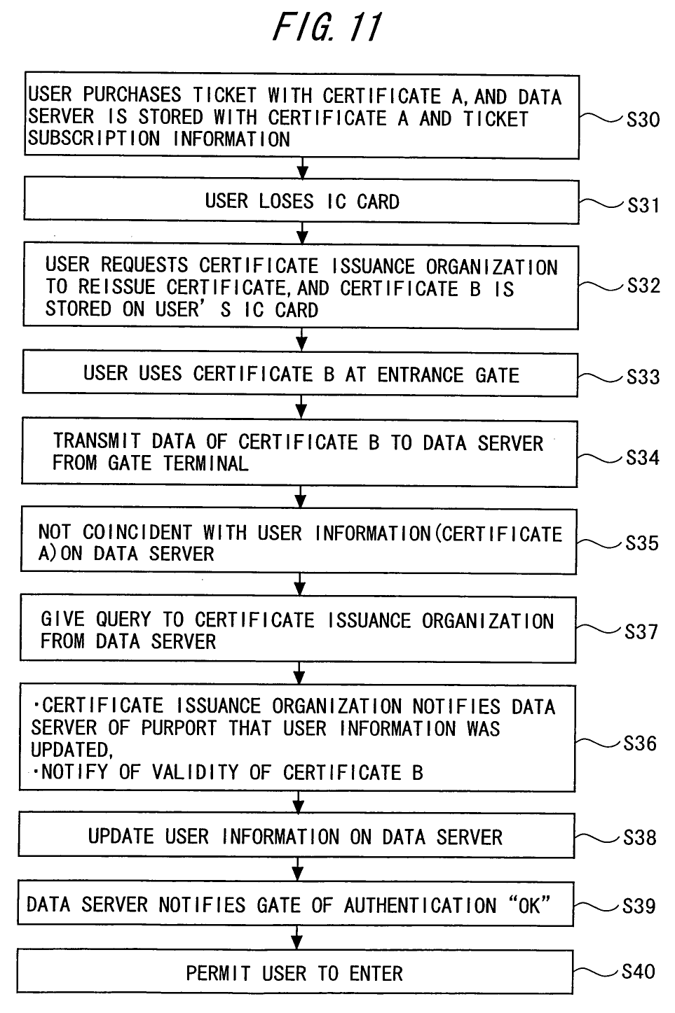

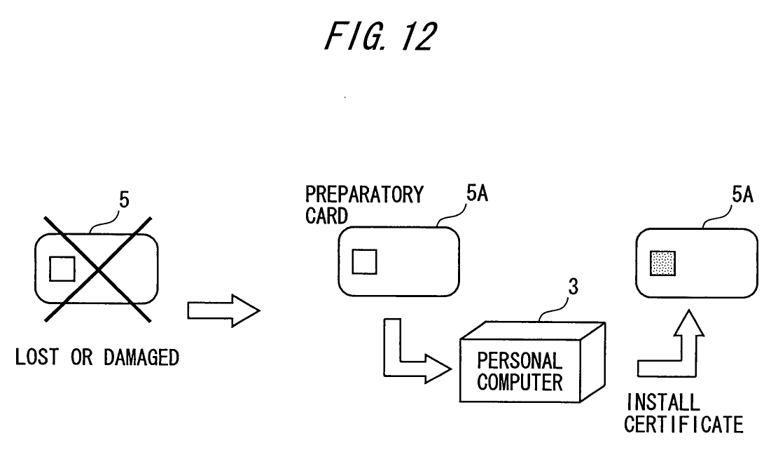

The information system according to a second embodiment of the present invention will be described with reference to the drawings in FIGS. 9 through 12. FIG. 9 is a view of a whole architecture of this information system. FIG. 10 shows an example of the certificate data in the information system. FIG. 11 shows an example of a flowchart showing a reissuing process of the certificate in the information system. FIG. 12 is a conceptual diagram showing a procedure of reissuing the certificate for the user.

The first embodiment discussed above has exemplified the information system that provides the function by which the user subscribes and purchases or utilizes the commercial article or the service, etc. by use of the certificate data stored on the IC card issued from the authentication station 6. The second embodiment will exemplify the information system that provides a reissuing function if the certificate data or the IC card 5 stored with the certificate data is lost. Other configurations and operations are the same as those in the first embodiment. Such being the case, the same components are marked with the same numerals and symbols as those in the first embodiment, and their explanations are omitted. Further, the drawings in FIGS. 1 through 8 are referred to when the necessity arises.

System Architecture

FIG. 9 shows the view of the whole architecture of this information system. This information system includes, as in the first embodiment, the data server 1, the authentication station 6, the user terminal 3, the gate management device 4 and the IC card 5 carried by the user. These components have been described in the first embodiment. The following discussion deals with an outline of a process if the user loses the IC card 5 stored with the certificate data. The numerals (1.) through (10.) given below correspond to the numerals attached to the arrows in FIG. 9.

(1.) If lost or encountering burglar, etc., the user request the authentication station 6 (CA station) as a certificate issuance organization to reissue the certificate data.

(2.) The authentication station 6, after confirming the identity of an applicant, reissues the certificate data. A serial number (issuance count) in the reissued certificate data is incremented.

(3.) The user presents the certificate to the gate management device 4 at the entrance gate of the concert subscribed by use of the reissued certificate.

(4.) The certificate data read by inputting the valid PIN is sent to the data server 1.

(5.) The data server 1 queries the authentication station 6 about credibility of the certificate data. The authentication station 6 judges (genuineness of the certificate data) whether the certificate data is data authenticated by the authentication station 6 or not. Further, the authentication station 6 judges by referring to the issuance count of the certificate data whether the certificate data is the latest (updated) data or not.

(6.)(7.) When the authentication station 6 judges that the certificate data is genuine and updated, it follows that the validity of the certificate data is confirmed. The user concerned is judged credible, and the data server 1 sends the subscription information to the gate management device 4. Through these processes, the user receiving the reissued certificate data is permitted to enter.

Considered next is a case where a user who unlawfully acquired the card abuses the certificate data.

(8.) The user, who unlawfully acquired the card, happens to know the valid PIN and presents the certificate to the gate management device 4.

(4.) The readout certificate data is sent to the data server 1.

(5.) The data server 1 queries the authentication station 6 about the credibility of this certificate.

(6.) In this case, a result that a value of the issuance count is judged invalid is sent to the server from the certificate issuance organization.

(9.) The server sends this judged result to the gate management device 4.

(10.) As a result, the user unlawfully acquiring the card is not permitted to enter, and, if suspicious of the burglar, some measure can be imposed on this user.

Herein, the query “Is the certificate data valid?”, which is given from the data server 1 to the authentication station 6, may also be transmitted to the authentication station 6 each time the data server 1 receives the certificate data from the data management device 4. Further, only if the user's certificate data on the data server 1 is not coincident with the certificate data on the card carried by the user, such a query may be transmitted to the authentication station 6.

Data Structure

FIG. 10 shows a data structure for distinguishing between the certificate data reissued again as described above and the certificate data issued in the past. FIG. 10 exemplifies two types of certificates such as a certificate A and a certificate B.

As shown in FIG. 10, the certificate data contains a certificate identification ID, an issuance count and certificate data for other user information. Among these items, the certificate identification ID is information for identifying the identity of the certificate. The certificate identification ID is used for searching for the user using the registered certificate data.

Moreover, the issuance count is a data field that is updated when reissued. This data field is stored with a numeric value (numerals) to be incremented by way of a counter, thereby clarifying which number of issuance.

Namely, as in the table in FIG. 10, the issuance count (the increment data field for reissuing) is incremented in the certificate data when reissued, whereby it is judged from this incremented value whether the certificate data is updated by reissuing or not. Thus, the issuance count is used for judging whether the certificate data is updated or not.

The certificate data for other user information is information other than the information specified in ITU-T Recommendations X.509, etc. and is exemplified such as the public key, the effective term, the digital signature in the authentication station 6, and so on.

Processing Flow and Effect in System

FIG. 11 shows a flow of the reissuing process of the certificate data in this information system. An assumption is that the user at first purchases a ticket of a desired event by use of the certificate data A in the same procedure as in the first embodiment. The certificate data A and the subscription information of the ticket are thereby stored on the data server 1 (S30).

It is assumed that the user loses the IC card 5 in this state (S31).

Then, the user applies to the authentication station 6 (the certificate issuance organization) for reissuing the certificate (S32). This procedure is the same as when making the application for issuing the certificate data for the first time in the first embodiment. For example, the user may simply send the certificate request containing the user's public key to the authentication station 6. The user stores the IC card 5 with the reissued certificate data B. In this case, a PIN is set again in the IC card 5. The PIN is not necessarily the same as the PIN of the lost IC card 5, and the user may set the PIN afresh in the IC card for user.

Next, the user carries the IC card 5 containing the reissued certificate data B, and goes to the event hall. Then, the user uses the certificate data B at the entrance gate of the hall (S33). This intends to have the IC card 5 read by the card reader/writer of the gate management device 4.

In this case, as in the first embodiment, the PIN of the IC card 5 must be inputted.

The gate management device 4 (which is illustrated as a gate terminal in FIG. 11) transmits the certificate data to the data server 1 (S34).

The data server 1 searches for the subscription information on the basis of the certificate data B. Then, the data server 1 judges whether or not the certificate data coincident with the certificate data B is stored together with the subscription information. In this case, in the certificate data B, the issuance count is incremented, and the certificate data coincident with the certificate data B is not stored (S35). Then, the data server 1 queries the authentication station 6 (the certificate issuance organization) about the validity of the certificate B (S36).

The authentication station 6 detects that the certificate data A is updated into the certificate data B. Then, the authentication station 6 notifies the data server 1 that the certificate data B should be used in place of the certificate data A (S37).

The data server 1 updates the certificate data A recorded together with the subscription information of the user into the certificate data B (S38). Further, the data server 1 notifies the gate management device 4 of a purport of the authentication “OK” (S39). The data management device 4, when notified of the authentication “OK”, permits the user to enter (S40).

As discussed above, according to the information system in the second embodiment, even if the user loses the IC card stored with the certificate data, the user can receive the reissued certificate data.

In this case, the reissued certificate data is attached with the issuance count and can be validated while invalidating the lost certificate data.

For instance, the reissued certificate data is stored on the IC card 5, and the gate management device 4 at the event hall or the data server 1 may query the authentication station 6 that issues the certificate when used for entering the event, etc. subscribed before reissuing and when non-coincidence of the certificate occurs. Moreover, the gate management device 4 or the data server 1 may query the authentication station 6 each time the certificate data is received.

With this scheme of querying the authentication station 6 about the validity of the certificate data, the lost certificate data can be invalidated in safety, and the authentication can be surely accepted by use of the reissued certificate data.

### MODIFIED EXAMPLE

In the second embodiment, the user, when losing the IC card 5 stored with the certificate data, receives the reissued certificate data from the authentication station 6. For example, if the IC card stored with the certification data is damaged enough to become unusable, however, the user may do recovery by himself or herself.

FIG. 12 shows a user-based procedure of reissuing the certificate. In such a case, the user may simply install the certificate data backed up on, e.g., the terminal 3 (the personal computer) into a preparatory IC card 5A. In this case, however, the issuance count shown in FIG. 10 remains unchanged. Accordingly, if the IC card 5 is lost, the unlawful use can not be prevented by this reissuing procedure.

### Third Embodiment

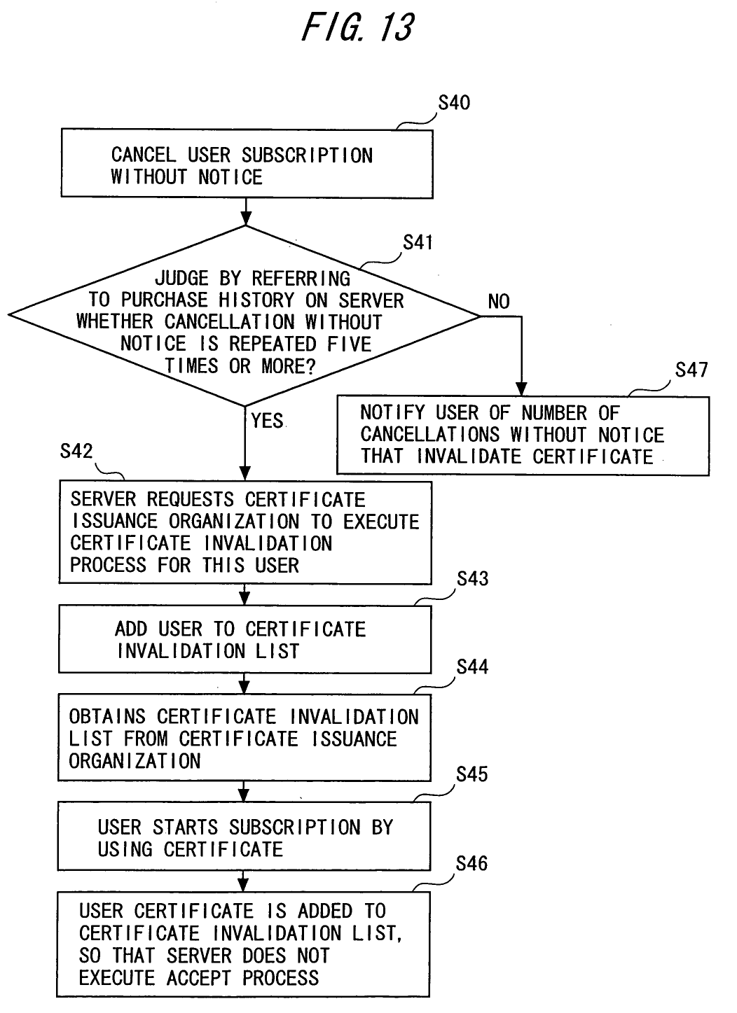

The information system according to a third embodiment of the present invention will be explained with reference to the drawing in FIG. 13. FIG. 13 shows an example of a flowchart showing a certificate invalidating process in this information system. The first embodiment has exemplified the information system that provides the function by which the user subscribes and purchases or utilizes the commercial article or the service, etc. by use of the certificate data stored on the IC card 5 issued from the authentication station 6. Further, the second embodiment has exemplified the information system in which the user, when losing the IC card 5, receives the reissued certificate data.

The third embodiment will exemplify the information system having a function of invalidating, when a predetermined condition occurs, the certificate data as such. Other configurations and operations are the same as those in the first embodiment or the second embodiment. Such being the case, the same components are marked with the same numerals and symbols as those in the first embodiment or the second embodiment, and their explanations are omitted. Further, the drawings in FIGS. 1 through 12 are referred to when the necessity arises.

FIG. 13 shows the certificate invalidating process in this information system. This process is a process of preventing the users who canceled without notice many times from executing the subscription process. Herein, “the cancellation without notice” connotes a situation that invalidates the subscription because of making none of the settlement by the term of payment though the commercial article or the service was subscribed.

Now considered is a case in which the term of payment of a certain user's subscription has passed and the subscription gets invalidated (S40). The data server 1 judges by referring to the purchase history whether or not the user cancelled without notice a predetermined number of times, e.g., five times or more (S41).

If the number of cancellations without notice does not reach the predetermined number of times, the processing is terminated as it is. At this time, however, the data server 1 may notify the user of the number of cancellations without notice that invalidates the certificate data (S47).

Whereas if the number of cancellations without notice reaches the predetermined number of times, the data server 1 applies to the authentication station 6 (the certificate issuance organization) for effecting the certificate invalidating process about this user (S42). This is attained in a way that may transmit, e.g., an e-mail requesting the certificate invalidating process to the authentication station 6 from the data server 1.

The authentication station 6 adds the identifying information (which is the certificate identification ID shown in FIG. 10) of this user to a certificate invalidation list (S43). The data server 1 obtains the certificate invalidation list from the authentication station 6 (S44).

On the other hand, the user requests the subscription by use of the certificate data (S45). Thereupon, the data server 1 detects that the certificate data of this user was added to the certificate invalidation list. As a result, the data server 1 (or the Web server 2 shown in FIG. 1) does not accept the subscription.

As discussed above, the information system in the third embodiment can invalidate the certificate of the user who canceled without notice many times.

The first embodiment through the third embodiment have exemplified the information systems that support, the authentication station 6 issuing the authentication information, providing the commercial article or the service on the basis of the thus issued authentication information. Then, the third embodiment has exemplified the information system in which the data server 1 requests the authentication station 6 for the certificate invalidation process.

The embodiment of the present invention is not, however, limited to these configurations. For instance, an administrator of the data server 1 may issue the authentication information in place of the authentication station. In such a case, an authentication server for issuing the authentication information may be provided. Further, the data server 1 may request this authentication server, as a substitute for the authentication station 6 in the third embodiment, for the certificate invalidation process. Moreover, the authentication server of such a type and the data server 1 may also be actualized on the single computer.

Storage Medium Readable by Computer

A program for making a computer, other device, machine, etc. (which will hereinafter be called a computer, etc.) actualize any one of the functions can be stored on a storage medium readable by the computer, etc. Then, the computer, etc. is made to read and execute the program on this storage medium, whereby the function can be provided.

Herein, the storage medium readable by the computer, etc. connotes a storage medium capable of storing information such as data, programs, etc. electrically, magnetically, optically, mechanically or by chemical action, which can be read from the computer and so on. Among these storage mediums, for example, a flexible disc, a magneto-optic disc, a CD-ROM, a CD-R/W, a DVD, a DAT, an 8 mm tape, a memory card, etc. are given as those demountable from the computer, etc.

Further, a hard disc, a ROM (Read-Only Memory), etc. are given as the storage mediums fixed within the computer, etc.

Data Communication Signal Embodied in Carrier Wave

Furthermore, the above program can be stored on a hard disk and a memory of the computer, etc., and can be distributed to other computers, etc. via communication media. In this case, the program is transmitted as data communication signals embodied in carrier waves via the communication media. Then, the computer, etc. receiving the distribution thereof can be made to provide the aforementioned functions.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

### Industrial Applicability

The present invention can be applied to a manufacturing industry of information processing devices such as computers, etc., and to a service industry that utilizing the information processing devices.

1. A subscription-based sales system including a portable device, a terminal device communicating with said portable device and a first server stored with data given from said terminal device,
said portable device comprising:
an identifying unit identifying a user by use of identifying information;
a storage unit stored with authentication information of a user identified by the identifying information; and
an external interface transferring and receiving the data to and from said terminal device,
said terminal device comprising:
an input device receiving an input of the identifying information of the user;
a device interface transferring and receiving the data to and from said portable device;
a unit transferring the identifying information to said portable device and instructing said identifying unit to identify the user;
a reading unit receiving, when said identifying unit could identify the user, the authentication information from said portable device;
a unit making the user subscribe a desired commercial article or service; and
a communication unit serving to store said first server with the authentication information and subscription information about the subscribed commercial article or service,
said first server comprising:
a storage unit stored with the authentication information and the subscription information in a way that associates the authentication information and the subscription information with each other.

2. A subscription-based sales system according to claim 1, said terminal device further comprising:
a unit referring to a list of the subscription information stored on said storage unit of said first server; and
a unit displaying the list of the subscription information.

3. A subscription-based sales system according to claim 1, further including a management device making management of providing the user with the subscribed commercial article or service,
said management device comprising:
an input unit receiving an input of the identifying information of the user;
a device interface transferring and receiving the data to and from said portable device;
a unit transferring the identifying information to said portable device and instructing said identifying a unit to identify the user;
a reading unit receiving, when said identifying unit could identify the user, the authentication information from said portable device;
a unit transmitting the authentication information to said first server;
a unit receiving a result of judgment as to whether the authentication information is stored together with the subscription information on said first server; and
a control unit permitting, when the authentication information is stored together with the subscription information on said first server, the user to be provided with the commercial article or the service.

4. A subscription-based sales system according to claim 3, said terminal device further comprising:
a unit applying to an issuance organization for reissuing the authentication information;
a unit obtaining the authentication information from said issuance organization; and
a unit storing said portable device with the obtained authentication information,
said first server further comprising a unit verifying validity of the reissued authentication information,
wherein said management device permits, when said first server verifies the validity of the authentication information received from said portable device, the user to be provided with the commercial article or the service.

5. A subscription-based sales system according to claim 1, said terminal device further comprising a unit accepting a settlement request about the subscription information,
said first server further comprising a unit executing a settlement process in response to the settlement request,
wherein said storage unit of the first server is stored with information showing completion of the settlement process together with the subscription information.

6. A subscription-based sales system according to claim 1, said first server further comprising a completion receiving unit receiving a completion-of-settlement report with respect to the subscription information,
wherein said storage unit of the first server is, when said completion receiving unit receives the completion-of-settlement report, stored with information showing the completion of the settlement together with the subscription information.

7. A subscription-based sales system according to claim 1, said first server further comprising:
a unit referring to a term of settlement with respect to the subscription information;
a unit recording, when the term of settlement passed and the subscription was invalidated, information about a user making the subscription;
a unit adding up a subscription invalidation count of the invalidated subscriptions per user; and
a unit invalidating the authentication information with respect to the user whose subscription invalidation count reaches a predetermined value.

8. A subscription-based sales system according to claim 1, further including an authentication server comprising:
a unit accepting from said first server a notice about a user whose subscription invalidation count representing how many times the subscription is invalidated due to an elapse over the term of settlement, reaches the predetermined or greater value; and
a unit invalidating the authentication information of the notified user when given the notice.

9. A subscription-based sales system according to claim 1, further including a second server providing information to be displayed on said terminal device and providing said first server with the information inputted from said terminal device.

10. A terminal device configuring a subscription-based sales system in linkage with a portable device comprising an identifying unit identifying a user by use of identifying information and a storage unit stored with authentication information of a user identified by the identifying information, and with a server comprising a storage unit stored with the authentication information and subscription information showing a subscription of a commercial article or a service by the user authenticated by the authentication information in a way that associates the authentication information and the subscription information with each other, said terminal device comprising:
an input unit receiving an input of the identifying information of the user;
a device interface transferring and receiving the data to and from said portable device;
a unit transferring the identifying information to said portable device and instructing said identifying unit to identify the user;
a reading unit receiving, when said identifying unit could identify the user, the authentication information from said portable device;
a unit making the user subscribe a desired commercial article or service; and
a communication unit serving to store said server with the authentication information and the subscription information related to the subscribed commercial article or service.

11. A terminal device according to claim 10, further comprising:
a unit referring to a list of the subscription information stored on said storage unit of said server; and
a unit displaying the list of the subscription information.

12. A management device conducting management of providing a user with a commercial article or a service in linkage with a portable device comprising an identifying unit identifying a user by use of identifying information and a storage unit stored with authentication information of a user identified by the identifying information, and with a server comprising a storage unit stored with the authentication information and subscription information showing a subscription of a commercial article or a service by the user authenticated by the authentication information in a way that associates the authentication information and the subscription information with each other, said management device comprising:
an input unit receiving an input of the identifying information of the user;
a device interface transferring and receiving the data to and from said portable device;
a unit transferring the identifying information to said portable device and instructing said identifying unit to identify the user;
a reading unit receiving, when said identifying unit could identify the user, the authentication information from said portable device;
a unit transmitting the authentication information to said server;
a unit receiving a result of judgment as to whether the authentication information is stored together with the subscription information on said server; and
a control unit permitting, when the authentication information is stored together with the subscription information on said server, the user to be provided with the commercial article or the service.

13. A management device according to claim 12, wherein said terminal device further comprises:
a unit applying to an issuance organization for reissuing the authentication information;
a unit obtaining the authentication information from said issuance organization; and
a unit storing said portable device with the obtained authentication information,
wherein said server further comprises a unit verifying validity of the reissued authentication information, and
wherein said control unit permits, when said server verifies the validity of the authentication information received from said reading unit, the user to be provided with the commercial article or the service.

14. A server configuring a subscription-based sales system in linkage with a portable device comprising an identifying unit identifying a user by use of identifying information and a storage unit stored with authentication information of a user identified by said identifying unit, and with a terminal device comprising an input unit receiving an input of the identifying information of the user, a device interface transferring and receiving the data to and from said portable device, a unit making said identifying unit identify the user by transferring the identifying information to said portable device, a reading unit receiving the authentication information from said portable device when said identifying unit could identify the user with a predetermined user, and a unit making the user subscribe a desired commercial article or service, said server comprising:
a unit receiving the authentication information and subscription information about the commercial article or the service subscribed by the user authenticated by the authentication information;
a storage unit stored with the authentication information and the subscription information in a way that associates the authentication information and the subscription information with each other; and
a unit outputting the stored subscription information or information as to whether the subscription is made or not.

15. A server according to claim 14, further comprising:
a unit judging validity of the authentication information stored on said storage unit of the server; and
a unit updating, when the authentication information is judged ineffective, the authentication information into an effective piece of authentication information.

16. A server according to claim 14, further comprising:
a unit accepting a settlement request about the subscription information via said terminal device; and
a unit executing a settlement process in response to the settlement request,
wherein said storage unit of the server is stored with information showing completion of the settlement together with the subscription information.

17. A server according to claim 14, further comprising a unit receiving a completion-of-settlement report about the subscription information,
wherein said storage unit of the server is stored with information showing completion of the settlement together with the subscription information.

18. A server according to claim 14, further comprising:
a unit referring to a term of settlement with respect to the subscription information;
a unit recording, when the term of settlement passed and the subscription was invalidated, information about a user making the subscription;
a unit adding up a subscription invalidation count of the invalidated subscriptions per user; and
a unit invalidating the authentication information with respect to the user whose subscription invalidation count reaches a predetermined value.

19. A server according to claim 14, further comprising:
a unit accepting a notice about a user whose subscription invalidation count representing how many times the subscription is invalidated due to an elapse over the term of settlement, reaches a predetermined value; and
a unit invalidating the authentication information of the notified user when given the notice.

20. A subscription-based sales method executed in a portable device, a terminal device communicating with said portable device and a server stored with data given from said terminal device, said method comprising:
a step receiving an input of identifying information of a user by said terminal device;
a step transferring the identifying information to said portable device and instructing an identifying unit to identify the user;
a step receiving, when said identifying unit could identify the user, the authentication information from said portable device;
a step making the user subscribe a desired commercial article or service; and
a step storing said server with the authentication information and subscription information about the subscribed commercial article or service.

21. A subscription-based sales method executed by a terminal device in linkage with a portable device comprising a storage unit stored with authentication information of a user and with a server comprising a storage unit stored with the authentication information and subscription information about a commercial article or a service by the user authenticated by the authentication information in a way that associates the authentication information and the subscription information with each other, said method comprising:
an input step receiving an input of identifying information of the user;
a step transferring the identifying information to said portable device and having the user identified;
a reading step receiving, when the user is identified, the authentication information from said portable device;
a step making the user subscribe a desired commercial article or service; and
a step storing said server with the authentication information and the subscription information about the subscribed commercial article or service.

22. A subscription-based sales method according to claim 21, further comprising a step referring to a list of subscription information stored on said storage unit of said server; and
a step displaying the list of the subscription information.

23. A management method of conducting management of providing a user with a subscribed commercial article or service by a management device in linkage with a portable device comprising a storage unit stored with authentication information of the user and with a server comprising a storage unit stored with the authentication information and subscription information showing a subscription of the commercial article or the service by the user authenticated by the authentication information in a way that associates the authentication information and the subscription information with each other, said method comprising:
an input step receiving an input of identifying information of the user;
a step transferring the identifying information to said portable device and having the user identified;
a step receiving, when the user is identified, the authentication information from said portable device;
a step transmitting the authentication information to said server;
a step receiving a result of judgement as to whether the authentication information is stored together with the subscription information on said server; and
a permitting step permitting, when the authentication information is stored together with the subscription information on said server, the user to be provided with the commercial article or the service.

24. A management method according to claim 23, further comprising a step requesting said server to verify validity of the received authentication information,
wherein said permitting step involves permitting, when the validity of the authentication information received from said portable device is verified, the user to be provided with the commercial article or the service.

25. A subscription-based sales method executed by a server comprising a storage device in linkage with a portable device comprising a storage unit stored with authentication information of a user, and with a terminal device receiving the authentication information from said portable device when the user can be identified by receiving an input of identifying information of the user, and making the user subscribe a desired commercial article or service, said method comprising:
a step receiving the authentication information and subscription information about a commercial article or service subscribed by the user authenticated by the authentication information;
a storing step storing the authentication information and the subscription information in a way that associates the authentication information and the subscription information with each other; and
a step providing the stored subscription information or information as to whether the subscription is made or not.

26. A subscription-based sales method according to claim 25, further comprising:
a step accepting a settlement request with respect to the subscription information via said terminal device;
a step executing a settlement process in response to the settlement request; and
a step storing information showing completion of the settlement with respect to the subscription information.

27. A subscription-based sales method according to claim 25, further comprising:
a step receiving a completion-of-settlement report with respect to the subscription information; and
a step storing the information showing the completion of the settlement with respect to the subscription information.

28. A subscription-based sales method according to claim 25, further comprising:
a step referring to a term of settlement with respect to the subscription information;
a step recording, when the term of settlement passed and the subscription was invalidated, information about the user who made the subscription;
a step adding up a subscription invalidation count representing how many times the subscription is invalidated per user; and
a step invalidating the authentication information with respect to the user whose subscription invalidation count reaches a predetermined value.

29. A subscription-based sales method according to claim 25, further comprising:
a step accepting a notice about a user whose subscription invalidation count representing how many times the subscription is invalidated due to an elapse over the term of settlement, reaches a predetermined value; and
a step invalidating the authentication information of the notified user when given the notice.

30. A subscription-based sales method according to claim 25, further comprising:
a step judging validity of the authentication information stored on said storage unit of the server; and
a step updating, when the authentication information is judged ineffective, the authentication information into an effective piece of authentication information.

31. An executable-by-computer program executed by a terminal device in linkage with a portable device comprising a storage unit stored with authentication information of a user and with a server comprising a storage unit stored with the authentication information and subscription information about a commercial article or a service by the user authenticated by the authentication information in a way that associates the authentication information and the subscription information with each other, said program comprising:
an input step receiving an input of identifying information of the user;
a step transferring the identifying information to said portable device and having the user identified;
a reading step receiving, when the user is identified, the authentication information from said portable device;
a step making the user subscribe a desired commercial article or service; and
a step storing said server with the authentication information and the subscription information about the subscribed commercial article or service.

32. A program according to claim 31, further comprising a step referring to a list of subscription information stored on said storage unit of said server; and
a step displaying the list of the subscription information.

33. An executable-by-computer program for making a management device conduct management of providing a user with a subscribed commercial article or service in linkage with a portable device comprising a storage unit stored with authentication information of the user and with a server comprising a storage unit stored with the authentication information and subscription information showing a subscription of the commercial article or the service by the user authenticated by the authentication information in a way that associates the authentication information and the subscription information with each other, said program comprising:
an input step receiving an input of identifying information of the user;
a step transferring the identifying information to said portable device and having the user identified;
a step receiving, when the user is identified, the authentication information from said portable device;
a step transmitting the authentication information to said server;
a step receiving a result of judgement as to whether the authentication information is stored together with the subscription information on said server; and
a permitting step permitting, when the authentication information is stored together with the subscription information on said server, the user to be provided with the commercial article or the service.

34. A program according to claim 33, further comprising a step requesting said server to verify validity of the received authentication information,
wherein said permitting step involves permitting, when the validity of the authentication information received from said portable device is verified, the user to be provided with the commercial article or the service.

35. A program executed by a server in linkage with a portable device comprising a storage unit stored with authentication information of a user, and with a terminal device receiving the authentication information from said storage unit when the user can be identified by receiving an input of identifying information of the user, and making the user subscribe a desired commercial article or service, said program comprising:
a step receiving the authentication information and subscription information about a commercial article or service subscribed by the user authenticated by the authentication information;
a storing step storing the authentication information and the subscription information in a way that associates the authentication information and the subscription information with each other; and
a step providing the stored subscription information or information as to whether the subscription is made or not.

36. A program according to claim 35, further comprising:
a step accepting a settlement request with respect to the subscription information via said terminal device;
a step executing a settlement process in response to the settlement request; and
a step storing information showing completion of the settlement with respect to the subscription information.

37. A program according to claim 35, further comprising:
a step receiving a completion-of-settlement report with respect to the subscription information; and
a step storing the information showing the completion of the settlement with respect to the subscription information.

38. A program according to claim 35, further comprising:
a step referring to a term of settlement with respect to the subscription information;
a step recording, when the term of settlement passed and the subscription was invalidated, information about the user who made the subscription;
a step adding up a subscription invalidation count representing how many times the subscription is invalidated per user; and
a step invalidating the authentication information with respect to the user whose subscription invalidation count reaches a predetermined value.

39. A program according to claim 35, further comprising:
a step accepting a notice about a user whose subscription invalidation count representing how many times the subscription is invalidated due to an elapse over the term of settlement, reaches a predetermined value; and
a step invalidating the authentication information of the notified user when given the notice.

40. A program according to claim 35, further comprising:
a step judging validity of the authentication information stored on said storage unit of the server; and
a step updating, when the authentication information is judged ineffective, the authentication information into an effective piece of authentication information.
